(19) United States
(12) Patent Application Publication
(10) Pub. No.: US 2009/0273419 A1
(43) Pub. Date: Nov. 5, 2009

(54) Switching device, in particular a compact starter

(76) Inventors: Norbert Mitlmeier, Ursensollen (DE); Norbert Zimmermann, Sulzbach-Rosenberg (DE)

Correspondence Address: HARNESS, DICKEY & PIERCE, P.L.C., P.O.BOX 8910, RESTON, VA, 20195, US

(21) Appl. No.: 12/310,791

(22) PCT Filed: Sep. 7, 2006
(86) PCT No.: PCT/DE2006/001567

§ 371 Date: Mar. 6, 2009

(51) Int. Cl. H02H 7/22; H02H 7/00; H01H 51/00

(52) U.S. Cl. 335/127; 361/62; 361/63

(57) ABSTRACT

In one example embodiment of the present application, the switching device includes a first switching point for normal switching of at least one current path, and includes a second switching path for disconnection of a short-circuit current. The first and second switching points are connected in series, and are accommodated in a common enclosure. Electrical connections and, if required, a control connection for inputting a switching command, are provided in or on the enclosure for connection of the current paths. The first switching point is designed for a maximum continuous current. The second switching point is designed to disconnect a short-circuit current which is a multiple of the maximum continuous current. The first switching point includes at least one main contact which can withstand a short-circuit at least for the time by means of a contact holding system or a contact locking system.

### PRIORITY STATEMENT

This application is the national phase under 35 U.S.C. § 371 of PCT International Application No. PCT/DE2006/001567 which has an International filing date of Sep. 7, 2006, which designated the United States of America, the entire contents of each of which are hereby incorporated herein by reference.

### FIELD

At least one embodiment of the present invention generally relates to a switching device which has a first switching point for normal operational switching of at least one current path and a second switching point for disconnecting a short-circuit current. In at least one embodiment, the first and second switching points are connected in series.

### BACKGROUND

Switching devices, in particular low-voltage switching devices, can be used to switch the current paths between electrical supply equipment and loads and therefore to switch their operating currents. This means that the connected loads can be activated and deactivated safely and reliably by the switching device's opening and closing current paths.

For the purpose of switching the current paths, an electrical low-voltage switching device has one or more elements called main contacts which can be controlled by one or more control magnets. A low-voltage switching device can be e.g. a contactor, a circuit breaker, a motor feeder or a compact starter. In principle the main contacts include a moving contact bridge and fixed contact pieces to which the load and the supply equipment are connected. A corresponding switch-on or switch-off signal is passed to the control magnets in order to close and open the main contacts. By way of their armatures the control magnets act on the moving contact bridges in such a way that the contact bridges complete a relative movement with respect to the fixed contact pieces. In this way the current paths that are to be switched can be closed or opened.

If a main contact of the switching device is worn out or even welded, the switching device can no longer safely and reliably disconnect the load even though a switch-off command is present. In the case of a welded contact, at least the current path having the welded main contact will then still carry current and be live. Consequently the load is not completely disconnected from the supply equipment. Since the load remains in a non-safe state, the switching device represents a potential fault source.

In order to solve the problem, switching devices are known which consist of two conventional switching devices connected in series, such as e.g. a contactor and circuit breaker or a contactor and overcurrent relay. The contactor serves for the normal operational switching (switching function) of a load, whereas the circuit breaker only intervenes in the event of a short-circuit (protection function). The two switching devices are usually connected mechanically and electrically to each other by way of a connection module. A combination of switching devices of this type is also referred to as a motor feeder.

If a main contact is thus welded at the end of its useful life, the protection function is still maintained even thereafter. For if e.g. a motor is forced to brake via a mechanical stop in an installation, the circuit breaker will detect the overloading of the motor. The circuit breaker automatically disconnects before further damage arises in the installation.

If, however, a short-circuit current is applied to a motor feeder of said kind, such as e.g. due to a technical fault in the connected load, then the circuit breaker will disconnect the short-circuit current. The switching contacts of the contactor weld due to the short-circuit current which is much higher by comparison with the maximum rated current. The cause of this is the high short-circuit current, which leads to a slight opening of the switching contacts. An arc forms between the switching contacts, causing the contact surfaces of the switching contacts to fuse. When the short-circuit current is reduced, the switching contacts close again and are welded together as the fused contact surfaces solidify. The contactor is defective following the short-circuit. A disadvantageous aspect therein is that the contactor must be replaced after the short-circuit incident. Substantial costs can be incurred due to the consequences of an installation shutdown.

In order to solve the aforementioned problem, what are termed compact feeders or compact starters having only one switching point are known. With commercially available compact starters, the switching point is opened in the event of a short-circuit, thereby preventing welding. However, one or more bridges of the three phases of a switching point of this type can weld at the end of its useful life. If, for example, the installation continues running and goes into overload, such switching devices do not detect that an overload is present. Due to the welding, however, the corresponding load also can no longer be disconnected. The protection function is no longer provided. Considerable damage to the installation can ensue as a consequence.

Fault sources of said kind must be avoided to ensure safe and reliable operation of switching devices and hence protection of the load and the electrical installation.

### SUMMARY

At least one embodiment of the present invention discloses a switching device which reduces or even avoids at least one of the aforementioned disadvantages.

According to at least one embodiment of the invention, the first and second switching points are accommodated in a common housing. For the purpose of connecting the current paths, electrical terminals and where applicable a control terminal for inputting a switching command are present in or on the housing. The first switching point is rated for a maximum continuous current. The second switching point is rated for (repeated) disconnection of a short-circuit current which can amount to a multiple of the maximum continuous current. The first switching point has at least one main contact which can be held open or closed at least for the duration of a short-circuit by way of a contact hold-open system or a contact hold-closed system.

The contact hold-open system or contact hold-closed system prevents a welding of the first switching point in the event of a short-circuit.

Integrating the first and second switching points, i.e. a switching device for the switching function and a switching device for the protection function, simplifies the design of a switching device of said type considerably. A separate connection module for connecting the first and second switching point is not necessary.

A further great advantage is that the protection function of the switching device according to at least one embodiment of the invention is maintained both in the case of a short-circuit and in the case of welded main contacts of the first switching device. In the case of a short-circuit the main contacts of the first switching device are held open or closed by the contact hold-open system or contact hold-closed system, as the case may be. No damage to the main contacts occurs. If one of the main contacts of the first switching device is worn out at the end of its useful life and consequently welded, the current paths are disconnected by way of the second switching point.

According to at least one embodiment of the invention the first switching point henceforth only needs to be rated such that it can (just) still handle a short-circuit current without damage until the time of disconnection by the second switching point. The second switching point needs to be rated for a maximum short-circuit current in configuration terms.

An inventive switching device of this kind is consequently more compact and more reliable. As a result of the integration of the two switching points in one housing, an undesirable technical modification or a non-optimal performance-related matching of the respective parameters of the two switching points to one another is not possible.

In a first embodiment, the contact hold-open system has an in particular electromagnetic actuator which opens the at least one main contact by way of a contact slide in the event of a short-circuit and holds the main contact open until the short-circuit current is disconnected by way of the second switching point.

The actuator can, for example, operatively interact in mechanical engagement with the contact slide which, for the purpose of normal operational switching, is connected to a switching drive or control magnet of the first switching device. Alternatively, the actuator can actuate the main contacts directly also by way of a further contact slide that is independent of the aforementioned contact slide.

As an alternative to the previous embodiment, the contact hold-closed system can have an in particular electromagnetic actuator which holds the at least one main contact closed by way of a contact slide until the short-circuit current is disconnected by way of the second switching point.

For example, it is possible for the electromagnetic actuator of the contact hold-open or contact hold-closed system to have an electromagnet. The electromagnet is in particular a solenoid or lifting magnet which is connected into at least one of the current paths for electrical excitation purposes.

Associated therewith is the advantage that especially in the case of a short-circuit the energy required for holding the main contacts open or closed can be taken from the current path. No separate energy store is required.

The actuator can have an in particular mechanical, pneumatic, electrical or electromechanical damping device which does not allow the actuated contact slide to return to the home position after discontinuation of the electrical excitation until after a delay time has elapsed. What is essential is that in the case of a short-circuit the main contacts are actuated as quickly as possible in order to hold said contacts open or, as the case may be, closed. In particular the actuation should take place within a few milliseconds. In contrast, the contact slide should release only after a time period of 20 to 200 milliseconds.

A mechanical damping device can have for example a spring-loaded system which allows the contact slide to return in a damped manner after the delay time. A pneumatic damping device can have e.g. a pressure cylinder which is impinged with compressed air in the case of a short-circuit and which allows the excess pressure to be relieved only in a delayed manner. An electrical damping device can have e.g. a diode freewheeling circuit or a buffer capacitor. The stored electrical energy delays the decaying of the magnetic field which holds the actuator in the actuated position. Combinations of the aforementioned damping options are also conceivable.

In a further embodiment the second switching point has a short-circuit current detector which outputs a control signal if a short-circuit occurs. The at least one main contact of the first switching point can then be opened by way of the electromagnetic actuator in response to the control signal.

As an alternative to the previous embodiment, the second switching point has a short-circuit current detector which outputs a control signal if a short-circuit occurs. The at least one main contact of the first switching point can be held closed by way of the electromagnetic actuator in response to the control signal.

The short-circuit current detection of the second switching point can be implemented e.g. by way of a coil, a current transformer or a measuring resistor. The control signal provided by the short-circuit current detector excites or controls preferably the electromagnetic actuator of the first switching point. The control signal provided can be electrically buffered on the part of the short-circuit current detector, e.g. by way of a capacitor, so that the electromagnetic actuator can return to its idle position after a delay. The signal can also be generated by way of an electronic timer module or by way of a microcontroller e.g. as part of the short-circuit current detector.

Furthermore, an electronic control unit, such as e.g. the aforementioned microcontroller, can also take over control and monitoring functions both of the first and of the second switching point. The control tasks can relate to switching commands for switching the first and for releasing the second switching point. The monitoring tasks can relate to short-circuit current monitoring as well as possibly to overcurrent monitoring in the device. For diagnosis at a higher level, the electronic control unit can have e.g. a bus interface. In the event of a fault or in the case of the second switching point being released a corresponding message can be relayed e.g. to a higher-ranking control center.

The particular advantage of the two previous embodiments lies in the inventive interaction between the first and second switching points. In this case the second switching point makes a short-circuit signal already detected by way of the short-circuit current detector available to the first switching point as a control signal.

In a special embodiment the second switching point has break contacts which can be opened in the case of a short-circuit by way of a releasing mechanism. The second switching point actuates a hold-open pusher operatively interacting with the releasing mechanism. The at least one main contact of the first switching point can be held open by way of the hold-open pusher. In particular the hold-open pusher can be actuated at least for the duration of the short-circuit. As an alternative to the previous embodiment the second switching point has break contacts which can be opened in the case of a short-circuit by way of a releasing mechanism. The second switching point actuates a hold-closed pusher operatively interacting with the releasing mechanism. The at least one main contact of the first switching point can be held closed by way of the hold-closed pusher. In particular the hold-closed pusher can be actuated at least for the duration of the short-circuit.

In order to open break contacts, the hold-open or, as the case may be, hold-closed pusher is preferably mechanically coupled to the contact slide. For example, a switching lock which actuates the contact slide can be present for the purpose of opening the break contacts. The hold-open or, as the case may be, hold-closed pusher can also be mechanically linked to the switching lock. The switching lock can have a spring-loaded energy accumulator which is released in order to open the break contacts in the event of a short-circuit.

The switching lock or releasing mechanism of the second switching point can be embodied with regard to the mechanical force released in the case of a short-circuit in such a way that the main contacts of the first switching point can be forced open via the hold-open pusher of the second switching point. As already explained in the introduction, welded main contacts occur in particular at the end of the useful life of the first switching device.

The special advantage of the two previous embodiments lies in the inventive interaction between first and second switching points. In this case, in order to avoid a welding of the contacts, the second switching point mechanically actuates the main contacts of the first switching point directly, without any intervention on the part of the first switching point itself.

The hold-open or hold-closed pusher is preferably linked to an in particular mechanical or pneumatic damping device. The damping device allows the hold-open or hold-closed pusher to return to its home position only after a delay time. The delay time can be selectable. As described hereintofore, the damping device can be embodied in different ways.

According to an advantageous embodiment, the first switching point has at least one main contact which can be activated and deactivated and at least one switching drive having a moving armature. The at least one main contact has fixed contact pieces and a moving contact bridge. The contact hold-closed system has a magnetic field concentrator with a U-shaped profile made of a magnetic material. The magnetic field concentrator encloses the fixed contact pieces and the moving contact bridge while maintaining a minimum voltage gap or a minimum air gap.

The magnetic field concentrator can also be embodied as C-shaped or V-shaped. What is crucial with regard to the geometrical embodiment and the arrangement in the first switching point is that the magnetic field concentrator encloses only the moving contact bridge without making contact with the live and current-carrying parts of the switching device. It is also critical that the magnetic field concentrator is embodied as half-open in the area of the contact bridge.

According to an embodiment of the invention, the magnetic field concentrator concentrates or condenses the magnetic flux in the end region of the U-shaped profile or U-shaped bracket. Owing to the local high magnetic field in the end region, the contact bridge that otherwise tends to open is pressed into the U-shaped profile if a short-circuit occurs. The main contacts of the first switching point are advantageously held closed at least for the duration of a short-circuit. The profile or bracket is manufactured from a magnetic, in particular ferromagnetic, material. The magnetic material has in particular a permeability number μᵣ of at least 100, for example 1000. A magnetic field with a substantially higher magnetic induction is generated in the magnetic material by way of the conductor magnetic field of the current path. In the case of a short-circuit, in addition to the contact spring force the magnetic field thus induced presses the contact bridge onto the fixed contact pieces of the first switching point. An opening of the contact bridge is effectively prevented. The at least one main contact is prevented from welding before the short-circuit is disconnected by way of the second switching point.

In particular the U-shaped profile of the magnetic field concentrator has arms with a length such that the ends of the arms are arranged at least roughly in the region of the contact bridge for the purpose of concentrating the magnetic flux. In particular the ends of the arms are arranged in the region of the open contact bridge.

Preferably the U-shaped profile has a top side with a recess for feeding the current paths. The recess is embodied in such a way that a minimum voltage gap or a minimum air gap is maintained from the live and current-carrying parts, in particular the current paths.

The magnetic field concentrator can also be implemented in two parts, with U-shaped profiles of the magnetic field concentrator in each case being disposed spaced apart from each other in the region of the two fixed contact pieces while maintaining a minimum voltage gap or a minimum air gap. In this case the magnetic field concentrator can be manufactured from a magnetic metal plate, such as e.g. from iron or nickel. Owing to the minimum voltage gap an arc occurring during the contact interruption cannot take the electrically “shorter” path by way of the electrically conductive metal plate. In certain conditions it would not be possible for the arc to be quenched and the current path safely and reliably broken by way of the main contacts. For example, the magnetic field concentrator or the U-shaped profile can be manufactured from a non-conducting magnetic material such as e.g. ferrite. In this case the one-part embodiment of the magnetic field concentrator in particular is advantageous.

The first switching point is in particular a contactor. The contactor serves for the switching function of the switching device. The contactor is actuated by electrical excitation of the control magnet or switching drive of the contactor by way of a trigger signal. The trigger signal can be supplied to the contactor by way of the control input disposed on or in the housing. The trigger signal can also be generated, for example cyclically, within the switching device, such as e.g. by way of a timing element. The first switching device or, as the case may be, the contactor is typically rated for a number of switching actions in the order of several thousands.

The second switching point is in particular a circuit breaker. The circuit breaker has in particular a switching lock for actuating the break contacts. The switching lock can be “pretensioned” manually or also by remote control and thus be reactivated. Typically, the second switching point need only be rated for comparatively few switching actions, e.g. 100.

In principle the first switching point and/or second switching point can be embodied for disconnecting an overcurrent. The overcurrent can amount to a maximum of twice the continuous current. This enables temporary, though not sustained currents to be switched as well.

In an example embodiment, the switching device is a three-pole switching device having three main contacts for activating and deactivating three current paths and having three break contacts for disconnecting a short-circuit current.

Preferably the switching device is a motor feeder or a compact starter.

### BRIEF DESCRIPTION OF THE DRAWINGS

The invention and advantageous embodiments of the same are described in more detail below with reference to the following figures, in which:

FIG. 1 shows an electrical circuit diagram of a switching device consisting of two independent, series-connected switching points according to the prior art,

FIG. 2 shows an electrical circuit diagram of a switching device having only one switching point for a simultaneous switching and protection function according to the prior art,

FIG. 3 shows an example of a switching device according to an embodiment of the invention having a common housing,

FIG. 4 shows an electrical circuit diagram of a switching device having a contact hold-open system according to an embodiment of the invention,

FIG. 5 shows an electrical circuit diagram of the switching device according to FIG. 4 in a first embodiment,

FIG. 6 shows an electrical circuit diagram of the switching device according to FIG. 4 in a second embodiment,

FIG. 7 shows an electrical circuit diagram of the switching device according to FIG. 4 in a third embodiment,

FIG. 8 shows an electrical circuit diagram of a switching device having a contact hold-closed system according to an embodiment of the invention,

FIG. 9 shows an electrical circuit diagram of the switching device according to FIG. 8 in a first embodiment,

FIG. 10 shows an electrical circuit diagram of the switching device according to FIG. 8 in a second embodiment,

FIG. 11 shows an electrical circuit diagram of the switching device according to FIG. 8 in a third embodiment,

FIG. 12 shows an example of an electromechanical actuator having a damping device,

FIG. 13 shows an example of a magnetic field concentrator in a contact hold-closed system of a switching device according to the invention in a sectional view,

FIG. 14 shows the example according to FIG. 13 in a sectional view along the drawn intersection line XIV-XIV, and

FIG. 15 shows by way of example the magnetic field profile of a magnetic field concentrator in a sectional view and in the case of a short-circuit.

### DETAILED DESCRIPTION OF THE EXAMPLE EMBODIMENTS

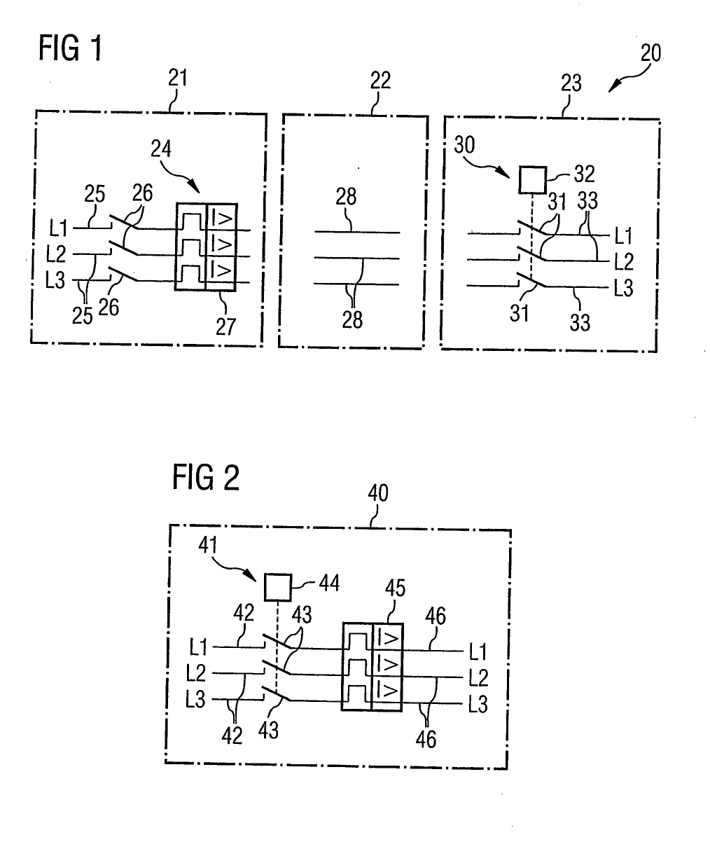

FIG. 1 shows an electrical circuit diagram of a series circuit 20 including two independent, series-connected switching devices 21, 23 according to the prior art. The first switching device 23 in the right-hand part of FIG. 1 has a first switching point 30. The first switching point 30 is e.g. a contactor and has a switching drive or a control magnet 32 for actuating main contacts 31. In the example shown in FIG. 1, the two switching devices 21, 23 are implemented as three-pole devices. The reference symbols L1-L3 designate current paths or current leads which can be opened or closed by way of the first switching point 30. The reference symbol 33 designates a load-side feed of the current paths L1-L3. The reference symbol 25 designates a line-side feed of the current paths L1-L3.

Shown in the left-hand part of FIG. 1 is a second switching device 21 which has a second switching point 24. The second switching point 24 is e.g. a short-circuit switch or circuit breaker, symbolized by a digital release signal and by the identifier I> for an exceeded reference current. The second switching point 24 has a switching lock (not shown in further detail) having a short-circuit current detector 27 for opening break contacts 26.

A connection module 22 is shown in the center part of FIG. 1. This enables the two switching devices 21, 23 to be mechanically and electrically connected together in the course of assembly. The respective connecting leads of the connection module 22 are designated by the reference symbol 28. As described in the introduction, the main contacts 31 of the first switching device 23 can disadvantageously weld due to the high short-circuit current in the event of a load-side short-circuit. The first switching device 23 must then be replaced.

FIG. 2 shows an electrical circuit diagram of a switching device 40 having only one switching point 41 for a simultaneous switching and protection function according to the prior art. The switching point 41 has a contactor 44 as well as a short-circuit switch or circuit breaker having a short-circuit current detector 45. The two switches act independently of each other on the common switching contacts 43. A load-side feed of the current paths L1-L3 is designated by the reference symbol 46. A line-side feed of the current paths L1-L3 is designated by the reference symbol 42.

As described in the introduction, the switching contacts 43 can weld at the end of their useful life. It will no longer be possible to interrupt a load in the event of a short-circuit or overcurrent situation.

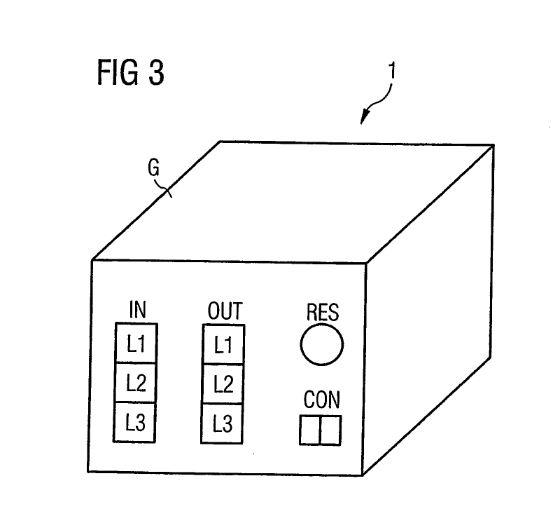

FIG. 3 shows an example of an inventive switching device 1 having a common housing G. Accommodated in the switching device 1 are a first switching point (not shown in further detail) for the normal operational switching of at least one current path L1-L3 and a second switching point for disconnecting a short-circuit current. In the present example three current paths L1-L3 are present. The first and second switching points are connected in series. Electrical terminals IN, OUT for connecting the current paths L1-L3 and a control terminal CON for inputting a switching command are present on the housing G. The electrical terminals IN, OUT can be disposed inside the device G, e.g. in the form of clamp-type terminals. A control magnet of the first switching point can be excited by way of the control terminal CON. The control terminal CON can also alternatively be a bus terminal for connecting [ . . . ] switching device 1 alternatively embodied e.g. for an automatic self-actuating cyclical operation, the control terminal can be dispensed with. The key designated by way of example by RES serves to reactivate the second switching device in the event of short-circuit or overcurrent tripping.

Preferably the first switching point 2 is a contactor and in particular a weld-free contactor. Contactors 2 of this type are typically rated for a number of switching actions in the order of several thousands.

Preferably the second switching point 3 is a circuit breaker or also a short-circuit switch. Circuit breakers or switches 3 of this type are rated for a small number, e.g. 100, switching actions.

The first switching point 2 and/or the second switching point 3 can be embodied for disconnecting an overcurrent, where the overcurrent can amount to twice the continuous current. Depending on the particular application, the overcurrent can amount to more or less than the double of the continuous current or rated current.

As described hereintofore, the switching device 1 is in particular a three-pole switching device 1 having three main contacts 9 for activating and deactivating three current paths L1-L3 and having three break contacts 5 for disconnecting a short-circuit current. Alternatively, the switching device 1 can also be embodied as a 2-, 4-, 5-pole or multi-pole device.

According to an example embodiment the switching device 1 is a motor feeder or a compact starter. Switching devices 1 of this type can be used as reliable and compact autonomous devices for protecting loads.

FIG. 4 shows an electrical circuit diagram of a switching device 1 having a contact hold-open system A according to an embodiment of the invention. A first switching point 2 for normal operational switching of, for example, three current paths L1-L3 and a second switching point 3 for disconnecting a short-circuit current are shown. The first and second switching points 2, 3 are connected in series. The reference symbol 4 designates a line-side feed and the reference symbol 10 a load-side feed of the current paths L1-L3.

According to an embodiment of the invention, the first switching point 2 is rated for a maximum continuous current. The second switching point 3 is rated for disconnecting a short-circuit current which can amount to a multiple of the maximum continuous current. The second switching point 3 additionally has a short-circuit current detector 6 and break contacts 5 for interrupting the current paths L1-L3 in the event of a short-circuit.

The first switching point 2 has at least one main contact 9 which can be held open by way of a contact hold-open system A at least for the duration ΔT of a short-circuit. The duration ΔT is a predefinable period of time and typically lies in a range of 20 ms to 200 ms, though in special application situations it can also be greater or less. The opening action of the contact hold-open system A is symbolized by an arrow. The first switching point 2 has a control magnet or a switching drive 8 for actuating a contact slide 11. The main contacts 9 can be opened and closed by way of the contact slide 11. The contact hold-open system A can be embodied in such a way that the main contacts 9 can likewise be held open by way of the contact slide 11 or alternatively by way of an additional separately implemented contact hold-open slide 11′.

According to one embodiment of the invention, the contact hold-open system A has an in particular electromagnetic actuator 12 which opens the at least one main contact 9 by way of the contact slide 11 or alternatively by way of the contact hold-open slide 11′ in the event of a short-circuit. Both contact slides 11, 11′ hold the main contacts 9 open until the short-circuit current is disconnected by way of the second switching point 3.

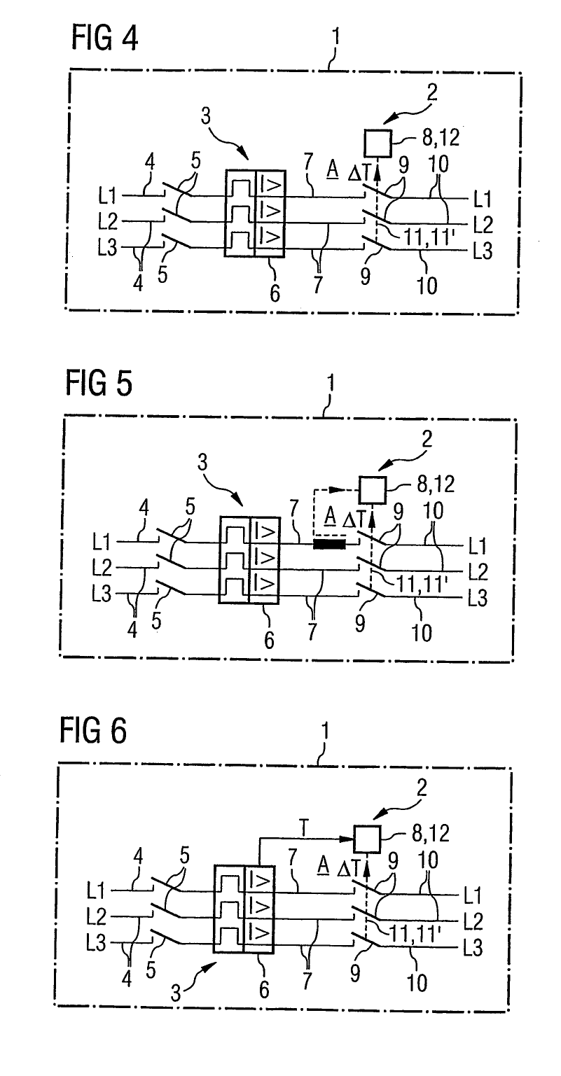

FIG. 5 shows an electrical circuit diagram of the switching device 1 according to FIG. 4 in a first embodiment. The actuator 12 has an electromagnet and in particular a solenoid or lifting magnet which is connected into at least one of the current paths L1-L3 for electrical excitation purposes. In the present FIG. 5 this is represented by the symbol for an electric coil and shown by way of example for one current path L1 only. In the case of a short-circuit the actuator 12 electrically excited due to the high short-circuit current such that an armature (not shown) movably linked to the actuator 12 is actuated. The dashed line shown running from the coil indicates the energy flow to the actuator 12. In the case of a short-circuit the armature can actuate the contact slide 11 or the contact hold-open slide 11′.

FIG. 6 shows an electrical circuit diagram of the switching device 1 according to FIG. 4 in a second embodiment. According to an embodiment of the invention, the second switching point 3 has the short-circuit current detector 6 which outputs a control signal T in the event of a short-circuit. The at least one main contact 9 of the first switching point 2 can be opened in response to the control signal T by way of the actuator 12.

The short-circuit current detector 6 can be realized e.g. by way of a coil, a current transformer or a measuring resistor. In the case of a coil or a current transformer the short-circuit signal T can be generated directly from the electrical voltage induced there and output to the electromagnetic actuator 12. The short-circuit signal T can be buffered e.g. by way of a capacitor. This causes the electromagnetic actuator 12 to return to its idle position only after a delay. The main contacts 5 are held open at least until the short-circuit current is disconnected and only then closed again.

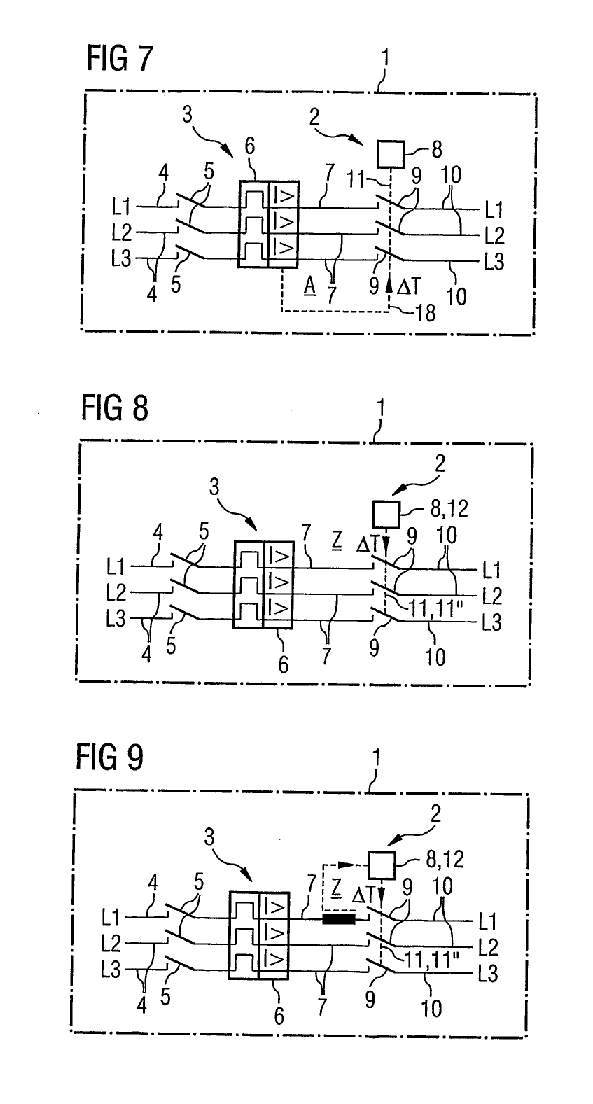

FIG. 7 shows an electrical circuit diagram of the switching device 1 according to FIG. 4 in a third embodiment. The second switching point 3 has break contacts 5 which can be opened in the event of a short-circuit by way of a releasing mechanism which is not shown in further detail. The second switching point 3 actuates a hold-open pusher 18 operatively interacting with the releasing mechanism. The at least one main contact 9 of the first switching point 2 can be opened by way of the hold-open pusher 18. In the example depicted in the present FIG. 7 three main contacts 9 are shown.

The hold-open pusher 18 is preferably mechanically coupled to a break contact slide (not referred to further) for the purpose of opening the break contacts 5. To effect the opening action, the second switching point 3 can have e.g. a switching lock which actuates the break contact slide. Alternatively, the hold-open pusher 18 can be coupled directly to the switching lock. Typically, the switching lock has a spring-loaded energy accumulator such as e.g. a cylinder spring made of spring steel. In the event of a short-circuit the spring-loaded energy accumulator or cylinder spring is released in order to open the break contacts 5.

The switching lock or the releasing mechanism can be embodied with regard to the mechanical force released in the event of a short-circuit in such a way that the main contacts 9 of the first switching point 2 can be forced open by way of the hold-open pusher 18. As explained in the introduction, contact welds can occur in particular at the end of the useful life of the first switching device, which is to say roughly after completion of the number of switching actions for which the first switching device is rated. In such a case a reclosing lockout, such as e.g. by way of a self-locking device, can also be present.

FIG. 8 shows an electrical circuit diagram of a switching device having a contact hold-closed system according to an embodiment of the invention. FIG. 8 differs from FIG. 4 in that the actuator 12 holds the at least one main contact 9 closed by way of a contact slide 11, 11″ until the short-circuit current is disconnected by way of the second switching point 3. As a result no arc which could damage the contact pieces of the main contacts 9 during the short-circuit is generated. In other respects the statements made with reference to FIG. 4 apply analogously to the present FIG. 8.

FIG. 9 shows an electrical circuit diagram of the switching device 1 according to FIG. 8 in a first embodiment. FIG. 9 differs from FIG. 5 in that the actuator 12 holds the main contacts 9 closed at least until the end of the short-circuit. In other respects the statements made with reference to FIG. 5 apply analogously to the present FIG. 9.

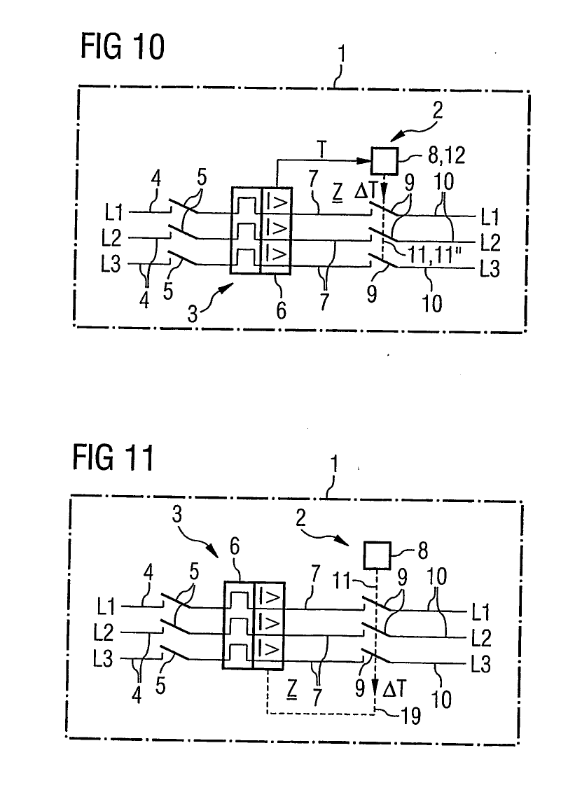

FIG. 10 shows an electrical circuit diagram of the switching device 1 according to FIG. 8 in a second embodiment. FIG. 10 differs from FIG. 6 in that the at least one main contact 9 of the first switching point 2 can be held closed in response to the control signal T by way of the electromagnetic actuator 12. In other respects the statements made with reference to FIG. 6 apply analogously to the present FIG. 10.

FIG. 11 shows an electrical circuit diagram of the switching device according to FIG. 8 in a third embodiment. FIG. 11 differs from FIG. 7 in that the second switching point 3 actuates a hold-closed pusher 19 operatively interacting with the releasing mechanism, by way of which hold-closed pusher 19 the at least one main contact 9 of the first switching point 2 can be held closed. In other respects the statements made with reference to FIG. 7 apply analogously to the present FIG. 11.

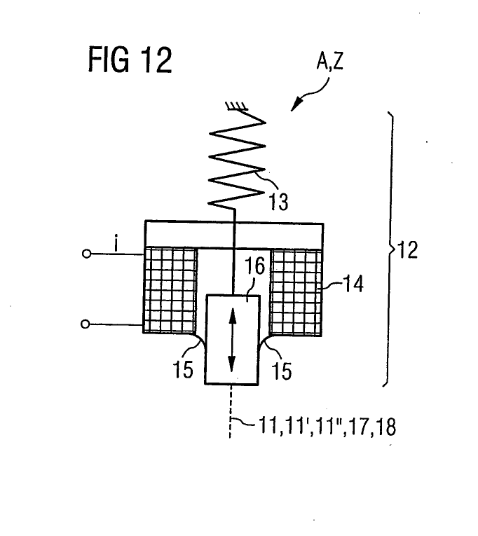

FIG. 12 shows an example of an electromechanical actuator 12 having a damping device 15. The actuator 12 has a pneumatic damping device 15. According to an embodiment of the invention, the damping device 15 does not allow the actuated contact slide 11, 11′, 11″ or, as the case may be, the actuated hold-open or hold-closed pusher 17, 18 to return to the home position after the discontinuation of the electrical excitation until after a delay time ΔT has elapsed.

The actuator 12 is, for example, a lifting magnet or solenoid having a concentrically embodied plunger coil 14. A current i is passed through the plunger coil 14 in order to excite it. A magnetic plunger body 16 is movably disposed inside the concentric plunger coil 14. Upon excitation by a current, the plunger body 16 is pulled into the plunger coil 14 against a spring 13. The plunger body 16 is connected to one of the contact slides 11, 11′, 11″ shown in the previous FIGS. 4 to 11 or to a hold-open pusher 18 or hold-closed pusher 19 for the purpose of actuating the main contacts 9.

When the plunger body 16 plunges into the plunger coil 14 it displaces the intermediate air. The air escapes without major flow resistance by way of a ring-shaped lip embodied as a damping device 15. After the plunger coil 14 is de-excited it returns into the idle position shown after a delay, since the negative pressure forming in the interior of the plunger coil 14 can dissipate only slowly by way of the ring-shaped lip 15 which now acts in a sealing manner. The damping device 15 shown allows the actuated contact slide 11, 11′, 11″ or the hold-open or hold-closed pusher 17, 18 to return to the home position following discontinuation of the electrical excitation only after a delay time ΔT has elapsed.

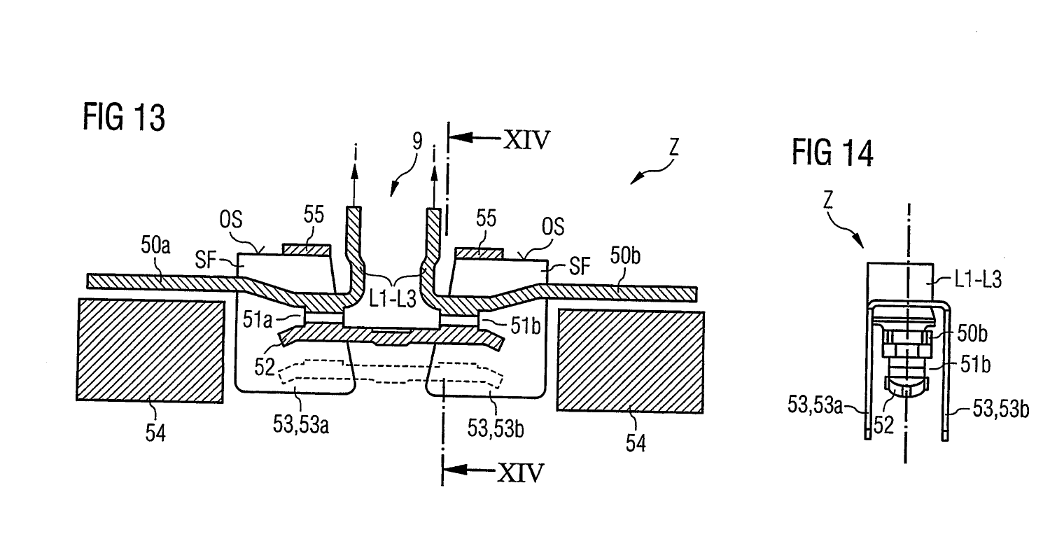

FIG. 13 shows an example of a magnetic field concentrator in a contact hold-closed system Z of a switching device 1 in a sectional view according to an embodiment of the invention. The first switching position 2 has at least one activatable and deactivatable main contact 9 as well as at least one switching drive having a moving armature. For reasons of clarity the switching drive and armature are not shown. Also, only one main contact 9 is shown to explain the active principle of the contact hold-closed system Z.

Furthermore, the main contact 9 has fixed contact pieces 51a, 51b and a moving contact bridge 52. Vertically shown feeds of the current paths L1-L3 and horizontally running extinction current paths 50a, 50b are connected to the fixed contact pieces 51a, 51b. The extinction current paths 50a, 50b lead to spark-quenching chambers 54 for quenching the arc resulting during the breaking of the main contact 9. In the case of the closed contact bridge 52 shown, the current flowing in and out via the main contact 9 is designated by the reference symbol i.

The contact hold-closed system Z has a magnetic field concentrator having an in particular U-shaped profile 53 made of a magnetic material such as e.g. iron or nickel. The planar (by way of example) side surfaces are designated by the reference symbol SF. The reference symbol OS designates the top side of the profile 53. The magnetic field concentrator encloses the fixed contact pieces 51 and the moving contact bridge 52 while maintaining a minimum voltage gap or minimum air gap.

The magnetic field concentrator can also be embodied as e.g. C-shaped. What is critical is that the magnetic field concentrator only encloses the moving contact bridge 52 without coming into contact with the live and current-carrying parts of the switching device. The minimum gap can lie in the range of 1 mm to 10 mm, depending on the voltage that is to be isolated. It is also critical that the magnetic field concentrator is embodied as half-open in the region of the contact bridge.

According to an embodiment of the invention the magnetic field concentrator concentrates or condenses the magnetic flux in the end region of the U-shaped profile 53 or U-shaped bracket. A magnetic field is generated in the magnetic material of the profile 53 and in the event of a short-circuit acts in addition to the contact spring force, pressing the contact bridge 52 onto the fixed contact pieces 51a, 51b of the first switching point. Opening of the contact bridge 52 is effectively inhibited. The main contact 9 is thus prevented from welding before the short-circuit is disconnected by way of the second switching point. The main contact 9 of the first switching point is consequently advantageously held closed at least for the duration of a short-circuit.

As already shown in FIG. 13, the magnetic field concentrator is implemented in two parts. U-shaped profiles 53a, 53b of the magnetic field concentrator are in each case disposed spaced apart from each other in the region of the two fixed contact pieces 51a, 51b while maintaining a minimum voltage gap or a minimum air gap. Owing to the minimum voltage gap an arc occurring during the contact interruption cannot take the electrically “shorter” path by way of the electrically conductive metal plate. In certain conditions it would not be possible to quench the arc.

According to one embodiment of the invention, the U-shaped profile 53 has arms with a length such that the ends of the arms are arranged at least roughly in the region of the contact bridge 52 for the purpose of concentrating the magnetic flux. In particular the ends of the arms are arranged in the region of the contact bridge 52 in the open state of the contact bridge 52.

The U-shaped profile 53 can have a recess on the top side OS for feeding the current paths L1-L3, in which case a minimum voltage gap or minimum air gap from the current-carrying and live parts of the first switching point should be maintained here also.

If, according to a further embodiment, the U-shaped profile 53 is manufactured from a non-conducting magnetic material such as e.g. ferrite, the magnetic field concentrator can also be implemented in a single piece owing to the non-conducting properties of the ferrite.

Referring to FIG. 13, permanent magnets are designated by the reference symbol 55. The permanent magnets 55 can pre-magnetize the U-shaped profile 53. This enables a magnetic field concentration to be embodied in the region of the ends of the arms without a current i flowing through the main contact 9. This embodiment is advantageous in the case of switching devices for switching direct current or direct voltages. As a result of the pre-magnetization the holding-closed force acting on the contact bridge 52 in the case of a short-circuit is particularly great.

FIG. 14 shows the example according to FIG. 13 in a sectional view along the drawn intersection line XIV-XIV. The U-shaped profile 53 of the magnetic field concentrator can be more clearly visualized in this view. As already described hereintofore, other cross-sectional shapes are also possible. In particular the side surfaces SF of the profile 53 do not have to be flat. They can also be embodied as curved, for example.

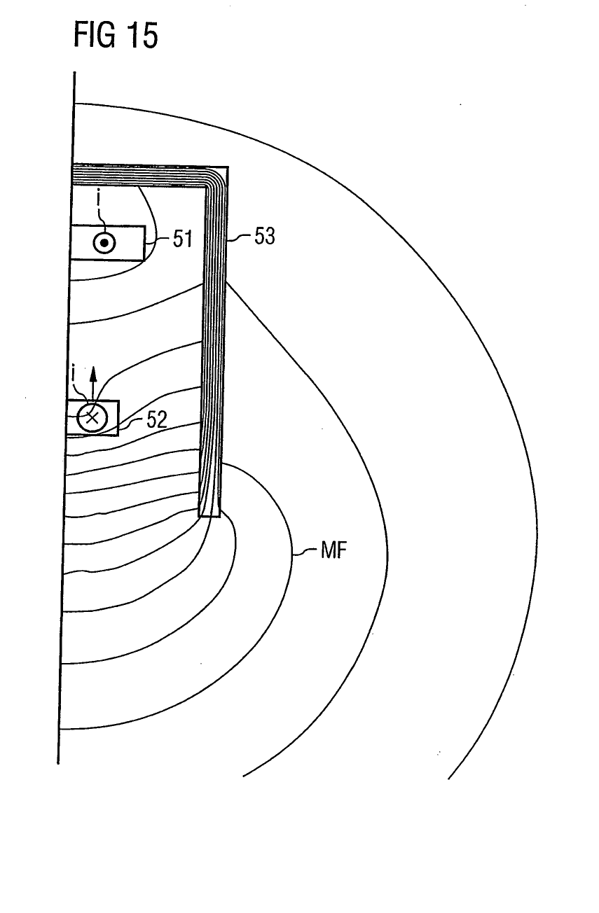

FIG. 15 shows by way of example the magnetic field profile of a magnetic field concentrator in a sectional view and in the case of a short-circuit. The magnetic field lines are designated by the reference symbol MF. The section through the exemplary magnetic field concentrator is made approximately along the intersection line XIV-XIV shown in FIG. 13. Only the magnetic field profile for half of the U-shaped profile 53 is shown. The magnetic field profile for the left-hand part of the U-shaped profile 53 is obtained by mirroring the magnetic field profile for the right-hand part of the U-shaped profile 53 at the drawn vertical line.

FIG. 15 shows by way of example the result of a computational simulation for the magnetic field profile in the case of a short-circuit. The fixed contact piece 51b and the contact bridge 52 are shown in a sectional view. The contact bridge 52 is in the closed state. Also included is the current direction of the current i flowing through the fixed contact piece 51b and through the contact bridge 52. In the sectional plane shown, the currents i flow in opposite directions, i.e. in relation to the fixed contact piece 51b the current flows vertically out of the image plane and in relation to the contact bridge 52 the current flows vertically into the image plane.

It is noted that the geometric position of the fixed contact piece 51b and the contact bridge 52 shown in FIG. 15 does not correspond to the geometric position of the fixed contact piece 51b and the contact bridge 52 shown in FIG. 13 and FIG. 14. However, the magnetic field profile would run in a similar manner for the geometric arrangement of the fixed contact pieces 51b and the contact bridge 52 according to FIG. 13 and FIG. 14.

As FIG. 15 shows, the magnetic field lines MF become concentrated in the region of the ends of the arms of the profile 53. The arrow drawn at the contact bridge 52 shows the force acting in the direction of the fixed contact piece or pieces 51b in the case of a short-circuit due to the magnetic field concentration. The contact bridge 52 remains closed.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A switching device comprising:
a first switching point for normal operational switching of at least one current path; and
a second switching point for disconnecting a short-circuit current,
the first and second switching points being connected in series and
being accommodated in a common housing, wherein
for the purpose of connecting the current paths, electrical terminals and where applicable a control terminal for inputting a switching command are present in or on the housing,
the first switching point is rated for a maximum continuous current,
the second switching point is rated for disconnecting a short-circuit current which amounts to a multiple of the maximum continuous current, and
the first switching point has at least one main contact which can be held open or closed by way of a contact hold-open system or a contact hold-closed system at least for the duration of a short-circuit.

2. The switching device as claimed in claim 1, wherein the contact hold-open system has an actuator which opens the at least one main contact by way of a contact slide in the event of a short-circuit and holds the contact open until the short-circuit current is disconnected by way of the second switching point.

3. The switching device as claimed in claim 1, wherein the contact hold-closed system has an electromagnetic actuator which holds the at least one main contact closed by way of a contact slide until the short-circuit current is disconnected by way of the second switching point.

4. The switching device as claimed in claim 2, wherein the actuator has an electromagnet which is connected into at least one of the current paths for electrical excitation purposes.

5. The switching device as claimed in claim 4, wherein the actuator has an in particular mechanical or pneumatic damping device which allows the actuated contact slide to return to the home position following discontinuation of the electrical excitation only after a delay time has elapsed.

6. The switching device as claimed in claim 2, wherein the second switching point has a short-circuit current detector which outputs a control signal in the event of a short-circuit, and wherein the at least one main contact of the first switching point is openable via the actuator in response to the control signal.

7. The switching device as claimed in claim 2, wherein the second switching point has a short-circuit current detector which outputs a control signal in the event of a short-circuit, and wherein the at least one main contact of the first switching point is holdable in a closed position via the actuator in response to the control signal.

8. The switching device as claimed in claim 2, wherein the second switching point has break contacts openable via a releasing mechanism in the event of a short-circuit, and wherein the second switching point actuates a hold-open pusher operatively interacting with the releasing mechanism and by which the at least one main contact of the first switching point is openable.

9. The switching device as claimed in claim 2, wherein the second switching point has break contacts which are openable via a releasing mechanism in the event of a short-circuit, and wherein the second switching point actuates a hold-closed pusher operatively interacting with the releasing mechanism and by which the at least one main contact of the first switching point is holdable in a closed position.

10. The switching device as claimed in claim 8, wherein the hold-open pusher is connected to a damping device which allows the hold-open pusher to return to the home position only after a delay time has elapsed.

11. The switching device as claimed in claim 1, wherein the first switching point has at least one activatable and deactivatable main contact and at least one switching drive having a moving armature,
the at least one main contact has fixed contact pieces and a moving contact bridge,
the contact hold-closed system has a magnetic field concentrator having a profile made of a magnetic material, wherein the magnetic field concentrator encloses the fixed contact pieces and the moving contact bridge while maintaining a minimum voltage gap.

12. The switching device as claimed in claim 11, wherein the profile is a U-shaped profile and
wherein the U-shaped profile has arms with a length such that the ends of the arms are arranged at least roughly in the region of the contact bridge for the purpose of concentrating the magnetic flux.

13. The switching device as claimed in claim 12, wherein the U-shaped profile has a top side having a recess for feeding the current paths.

14. The switching device as claimed in claim 11, wherein the magnetic field concentrator is implemented in two parts, with U-shaped profiles of the magnetic field concentrator in each case being disposed spaced apart from each other in the region of the two fixed contact pieces while maintaining a minimum voltage gap.

15. The switching device as claimed in claim 11, wherein the U-shaped profile is manufactured from a non-conductive magnetic material.

16. The switching device as claimed in claim 1, wherein
the first switching point is a contactor.

17. The switching device as claimed in claim 1, wherein the second switching point is a circuit breaker.

18. The switching device as claimed in claim 1, wherein at least one of
the first switching point and the second switching point is embodied for disconnecting an overcurrent, the overcurrent amounting to a maximum of twice the continuous current.

19. The switching device as claimed in claim 1, wherein the switching device is a three-pole switching device having three main contacts for activating and deactivating three current paths and having three break contacts for disconnecting a short-circuit current.

20. The switching device as claimed in claim 1, wherein the switching device is a motor feeder or a compact starter.

21. The switching device as claimed in claim 2, wherein the actuator is electromagnetic.

22. The switching device as claimed in claim 3, wherein the actuator has an electromagnet which is connected into at least one of the current paths for electrical excitation purposes.

23. The switching device as claimed in claim 4, wherein the electromagnet is a solenoid or lifting magnet.

24. The switching device as claimed in claim 22, wherein the electromagnet is a solenoid or lifting magnet.

25. The switching device as claimed in claim 22, wherein the actuator has an in particular mechanical or pneumatic damping device which allows the actuated contact slide to return to the home position following discontinuation of the electrical excitation only after a delay time has elapsed.

26. The switching device as claimed in claim 9, wherein the hold-closed pusher is connected to a damping device which allows the hold-closed pusher to return to the home position only after a delay time has elapsed.

27. The switching device as claimed in claim 12, wherein the magnetic field concentrator is implemented in two parts, with U-shaped profiles of the magnetic field concentrator in each case being disposed spaced apart from each other in the region of the two fixed contact pieces while maintaining a minimum voltage gap.
